(19) United States
(12) Patent Application Publication
(10) Pub. No.: US 2021/0404823 A1
(43) Pub. Date: Dec. 30, 2021

(54) METHOD FOR CONTROLLING AN AUTOMATED MOBILE UNIT AND METHOD FOR EMITTING A PIECE OF HAZARD INFORMATION

(71) Applicant: Robert Bosch GmbH, Stuttgart (DE)

(72) Inventors: Martin Kisser, Asperg (DE); Peter Walter, Ludwigsburg (DE)

(21) Appl. No.: 16/467,846

(22) PCT Filed: Oct. 24, 2017
(86) PCT No.: PCT/EP2017/077057

§ 371 Date: Jun. 7, 2019

(30) Foreign Application Priority Data
Dec. 13, 2016 (DE) 102016224815.4
Oct. 19, 2017 (DE) 102017218671.2

(51) Int. Cl. G01C 21/34; G05D 1/02

(52) U.S. Cl. CPC G01C 21/3461; G05D 1/0276; G05D 1/0214; G01C 21/3415

(57) ABSTRACT

A method for controlling, in particular for evacuating, a mobile unit operated in an automated manner. The method includes the following: receiving a signal from an external source, which encompasses a piece of hazard information; automated control of the mobile unit based on this piece of hazard information, the control taking place in such a way that the mobile unit is guided to a safe position for the mobile unit; automatically guiding the mobile unit based on the piece of hazard information and/or a received all-clear signal and/or a received guidance signal, the automatic guidance taking place so that the mobile unit is guided to a starting position of the mobile unit.

### FIELD OF THE INVENTION

The present invention relates to a method for controlling an automated mobile unit and to a method for emitting a piece of hazard information, and appropriate devices.

### BACKGROUND INFORMATION

Methods for the automated control of vehicles are provided from the related art. Systems are also believed to be provided, with the aid of which hazard information may be acoustically or visually received.

Patent document GB 2521415 A discusses a method for controlling a vehicle and for establishing an evacuation strategy for vehicles during an emergency.

### SUMMARY OF THE INVENTION

The present invention relates to a method for controlling, in particular, for evacuating, an automated mobile unit. The method includes the following steps:
receiving a signal from an external source, which encompasses a piece of hazard information;
automated control of the mobile unit based on this piece of hazard information, the control taking place in such a way that the mobile unit is guided to a safe position for the mobile unit;
automatically guiding the mobile unit based on the piece of hazard information and/or a received all-clear signal and/or a received guidance signal, the automatic guidance taking place in such a way that the mobile unit is guided to a starting position of the mobile unit.

This method offers the advantage that mobile units threatened by a hazard are warned and, if necessary, proposals for evacuation are transmitted to the mobile units. Due to an evacuation of the mobile unit carried out in an automated manner, damage to the mobile unit is prevented and/or access to hazardous areas is created for emergency personnel. In addition, the acceptance of an appropriate method for the automated control of a mobile unit on the part of a user, an owner, or a responsible party of the mobile unit is increased when the mobile unit is steered back in an automated manner to its starting position without having sustained damage.

The receipt of a signal from an external source may take place via a suitable interface in this case and does not necessarily need to be carried out by the unit on which the method is carried out. The method may be carried out, for example, on a control unit which includes an interface to a receiving unit which is capable of receiving signals from external sources. The same applies for the automated control of the mobile unit. A control unit on which the method is carried out does not need to include appropriate actuators itself, with the aid of which a mobile unit is actually controlled. “Control” is understood to mean that commands are generated and/or emitted, which effectuate a control of the mobile unit.

The safe position for the mobile unit may be determined by the mobile unit itself, for example, with reference to stored safe positions, on the basis of a calculation based on the piece of hazard information, and/or on the basis of a query of further internal and/or external information sources, such as databases.

Moreover, it is possible to receive a piece of information regarding a safe position, for example, from the same source which also provides the piece of hazard information. It is also conceivable that the piece of hazard information already encompasses a piece of information regarding a safe position for the mobile unit. Examples for safe positions are parking garages, garages, underground parking garages, covered areas, aircraft hangars, barns, storage locations for boats, harbors, bridges, underpasses, tunnels, and general areas which are not affected by the hazard indicated with the aid of the piece of hazard information.

An optional calculable route to the safe position for the mobile unit may be calculated in the mobile unit or on an external server. The calculation may incorporate the piece of hazard information in order, for example, to circumvent hazards for the mobile unit in the best way possible.

In one further specific embodiment of the method, the external source corresponds to an external server, a cloud, a user, and/or an owner of the mobile unit and/or a further mobile unit.

This specific embodiment of the present invention offers the advantage that multiple information sources may be utilized, all of which have the potential to forward hazard information. Due to the inclusion of one or multiple of these sources, the safety of the mobile unit may be enhanced. Among other things, multiple mobile units may exchange information with one another, whereby a fast and reliable information exchange is ensured.

In one further specific embodiment of the method, the piece of hazard information encompasses a location and/or an area which is affected by a hazard.

This specific embodiment offers the advantage that the piece of hazard information encompasses further pieces of information which are crucial for the safety of the mobile unit. On the basis of an indication of a location and/or an area which are/is affected by a hazard, the piece of hazard information may be prioritized by the mobile unit and the piece of hazard information may be appropriately responded to. As a result, the situation may be prevented in which too many mobile units unnecessarily head toward a safe position even though the present location of these mobile units is not affected by the piece of hazard information or the hazard. As a result, hazardous traffic situations or an excessive traffic volume may be avoided. In addition, the mobile unit may take this piece of information into account in the ascertainment of a safe position for the mobile unit.

In one further specific embodiment of the method, the method includes the step of receiving a signal which encompasses a piece of information regarding a safe position for the mobile unit. The automated guidance takes place based on this piece of information.

The received signal may correspond to the signal from the external source, which encompasses the piece of hazard information. Alternatively, the received signal may also be a separate signal.

This specific embodiment of the method offers the advantage that a safe position is already communicated to the mobile unit, whereby this position does not need to be determined and/or requested by the mobile unit. Depending on the present piece of hazard information, it may be advantageous that the safe position is determined by an external unit which has a greater amount of information, on the basis of which the safe position may be determined. Moreover, computing power of the mobile unit may be saved in this way. It is also conceivable that either a signal stored in the mobile unit or a signal determined by the external unit is selected, depending on the hazard signal. This implementation has the advantage, for example, that a non-overwritable default destination may always be approached. In addition, a limitation regarding the safe positions may be contained in an internal memory, for example, in the form of a maximum radius around an assigned position, so that the mobile unit is not guided to an arbitrarily distant, received position.

In one further specific embodiment of the method, the method includes the step of receiving a signal which encompasses a piece of information regarding at least one route to a safe position for the mobile unit. The automated guidance takes place based on this piece of information.

This signal may either be a separate signal which encompasses a piece of information regarding at least one route to a safe position for the mobile unit or, alternatively, may be a signal received in another step, which, in addition to further information, encompasses the piece of information regarding at least one route. For example, it is possible that the signal received by the external source, which encompasses a piece of hazard information, simultaneously also encompasses a piece of information regarding a route to at least one safe position for the mobile unit.

The piece of hazard information may be taken into account in a calculation of a route to a safe position for the mobile unit. For example, the route may be calculated on the basis of a movement of a storm, on the basis of impending riots and roads which, as a result, have been blocked off, or roads which should not be driven on. In this case, further pieces of information may also flow in, such as roads which have already been damaged due to natural disasters and/or phenomena, such as landslides and/or rock slides and/or heavy snowfall and/or extreme temperatures, and which, consequently, may be avoided in the selection of a route to the safe position. It is also conceivable that further data such as deployments of, for example, rescue or law enforcement personnel, traffic jam information, construction site blockages, detours, general obstructions, or information such as the suitability of the route for the size of the mobile unit are incorporated. For spacecraft, in addition, for example, information regarding impending meteor or solar radiation storms or, if necessary, space debris colliding with the spacecraft, is to be taken into account.

This specific embodiment of the present invention offers the advantage that the route does not need to be determined by the mobile unit itself, and the determination takes place based on a greater amount of information. As a result, the safety of the mobile unit may be enhanced. Moreover, computing capacity of the mobile unit may be saved when appropriate route planning is carried out on an external server. In addition, for the evacuation of several mobile units, the route planning may be carried out differently and, therefore, in an obstruction-avoiding manner.

In one further specific embodiment of the method, the method includes the step of emitting a signal to a user and/or an owner of the mobile unit and/or a party responsible for the mobile unit. This signal encompasses information regarding an automated control of the mobile unit.

This specific embodiment of the method offers the advantage that a user, an owner, or a responsible party is informed about an impending control and, if necessary, may affect the impending control. As a result, the safety of the mobile unit is enhanced.

In addition, the acceptance of an appropriate method on the part of a user, an owner, or a responsible party of the mobile unit is increased, since the mobile unit informs the user, the owner, or the responsible party about the planned controls. The user, the owner, or the responsible party may intervene in the control, if necessary, and therefore retains control of movements of his or her mobile unit.

In one further specific embodiment of the method, the method includes the additional step of receiving an acknowledge signal of the user and/or the owner and/or the party responsible for the mobile unit. The automated guidance of the mobile unit takes place based on the acknowledge signal.

The acknowledge signal may represent, on the one hand, a response to a query emitted previously to an owner, a user, and/or a responsible party. On the other hand, the acknowledge signal may also be of a general nature, which, for example, always permits or always prohibits automated controls after the receipt of a piece of hazard information.

This specific embodiment offers the advantage that the acceptance of an appropriate method for the automated control of a mobile unit on the part of a user, an owner, or a responsible party of the mobile unit may be increased.

In one further specific embodiment of the method, the method includes the step of receiving an all-clear signal which encompasses a further piece of hazard information and/or a guidance signal. The guidance of the mobile unit takes place, in this case, as a function of the all-clear signal and/or the guidance signal.

This specific embodiment of the present invention offers the advantage that the mobile unit contains instantaneous information regarding hazards, and an appropriate automated control of the mobile units is possible. The safety of the mobile units is enhanced as a result. Moreover, an intervention into the automated control may take place as a result of the receipt of a guidance signal which has been emitted, for example, by a user, an owner, and/or a responsible party of the mobile unit. Due to this option, the user, the owner, and/or the responsible party is given more control over the mobile unit, whereby the acceptance of an appropriate method for the automated guidance of a mobile unit on the part of a user, an owner, or a responsible party of the mobile unit is increased. The guidance signal may encompass, for example, the command to control the mobile unit in an automated manner in such a way that a predefined position is approached. This position may be independent of the piece of hazard information and, for example, may also lie in an area which is affected by the hazard situation. In addition, cases of misguidance may be avoided when automated controls initially require an acknowledgement by a user, an owner, and/or a responsible party.

In one further specific embodiment of the method, the method includes the additional step of controlling the mobile unit based on the piece of hazard information and/or the all-clear signal and/or the guidance signal. The control takes place in such a way, in this case, that the mobile unit is guided to a starting position of the mobile unit.

This control or this automatic guidance may take place chronologically after the automatic control which takes place based on the piece of hazard information. For example, the step of automatic guidance/control may be carried out when the hazard has passed, for example, based on an all-clear signal or a piece of information contained in the piece of hazard information regarding a period of time of the hazard or a time of day at which the hazard has passed. The aforementioned step may also take place when a signal of a user and/or a guidance signal calls for/contains an appropriate guidance. For example, when the user does not agree with the evacuation and/or the automatic control of the mobile unit.

A starting position may be understood, in particular, to be the position of the mobile unit, in which the mobile unit was located upon receipt of the signal from the external source, which encompasses a piece of hazard information. Moreover, it is conceivable that the starting position is understood to be a position in the proximity of the position in which the mobile unit was located upon receipt of the signal from the external source, which encompasses a piece of hazard information. The position may be, for example, a position in a predefined surrounding area which may be fixedly predefined by an owner, a user, and/or a responsible party. This surrounding area may be entered, for example, in the form of a radius entered in meters or kilometers. Moreover, it is possible that the surrounding area is established on the basis of a time specification within which the mobile unit is to reach a certain location. Consequently, a user of the mobile unit could establish the area in such a way that the mobile unit may reach its destination position within a predefined time specification, for example, five minutes.

The control may take place based on the signal received from the external source, which encompasses a piece of hazard information. This piece of hazard information may contain, for example, a period of time in which a hazard for the mobile unit is to be assumed. If the hazard for the mobile unit has passed, a further guidance of the mobile unit may take place based on the piece of hazard information, so that the mobile unit is guided to a starting position of the mobile unit.

Alternatively, the guidance may take place based on the all-clear signal which contains a piece of information indicating that the hazard for the mobile unit has passed.

It is also possible that the mobile unit heads for the starting position based on the guidance signal. This guidance signal may be completely independent of the piece of hazard information and/or present hazards for the mobile unit. A user, an owner, and/or a responsible party of the mobile unit may emit this guidance signal or a guidance command at any time.

This specific embodiment of the method offers the advantage that the acceptance of an appropriate method for the automated control of a mobile unit on the part of a user, an owner, or a responsible party of the mobile unit is increased. The mobile unit may be steered back to its starting position in an automated manner without having sustained damage. Moreover, it is possible for a user, an owner, and/or a responsible party to guide the mobile unit, in the event of false warnings, in such a way that the mobile unit moves back to its starting position in an automated manner.

In one specific embodiment of the method, the mobile unit operated in an automated manner is an automobile, a drone, a truck, a boat, a construction vehicle, a commercial vehicle, a tractor, an aircraft, or a spacecraft.

The method may be applied for any agricultural vehicle, watercraft, aircraft, or spacecraft operable in an automated manner.

Moreover, a device for controlling a mobile unit is provided, which is configured for carrying out the steps of the method according to one of the above-described embodiments of the method in appropriate units.

In addition, a method for emitting a signal is provided, which encompasses hazard information. This method includes the following steps:
receiving data;
generating a piece of hazard information on the basis of the received data;
ascertaining an area affected by the piece of hazard information;
receiving position data of at least one mobile unit;
ascertaining whether the mobile unit is located in the ascertained area; and
emitting a signal which encompasses the hazard information to the mobile unit if the mobile unit is located in the ascertained area.

The received data may be of a highly diverse nature in this case. The data may be weather warnings, warnings about natural disasters, such as fires, floods, landslides, or tsunamis, warnings about uprisings, protests, and/or demonstrations, shootings, or deployments of security forces. Moreover, the data may encompass positions of persons, such as positions of individual persons, which are ascertained with the aid of smartphones which the persons carry.

On the basis of the received data, a piece of hazard information is generated in the next step. The previously received data may be evaluated for this purpose. For example, warnings about storms or natural disasters may be generated on the basis of the data. It is also possible to detect crowds, demonstrations, or any other unusual events on the basis of data regarding the positions of multiple persons. A piece of hazard information could likewise be generated on the basis of this information. Such information may also be obtained from further external sources.

An area affected by the piece of hazard information may be understood to be an area which is directly affected by a hazard, for example, a district which is threatened by flooding. The affected area may also be selected to be larger than the directly affected area, however, so that adjacent districts are also included. Depending on the hazard situation, the aforementioned districts may likewise be affected by the piece of hazard information or the hazard. In order to define the affected area, for example, an area surrounding a detected or known danger may also be assumed, which is selected, for example, depending on the type of the hazard. In the case of unpredictable hazards, such as storm warnings or floods, the area would therefore be selected to be larger than in the case of hazards which occur very locally, such as a house fire.

In one further specific embodiment of the method, the method includes the step of determining a safe position for the mobile unit. In this case, the signal encompasses a piece of information regarding the safe position for the mobile unit.

The signal may be transmitted individually to individual units, the signal encompassing information regarding a safe position, which has been specifically adapted to the individual units.

Alternatively, this signal may also be transmitted to multiple mobile units which are located in an area affected by the hazard situation. The safe position for the multiple units may also encompass an area, in this case, which may be approached simultaneously by multiple mobile units, such as an underground parking garage having sufficient capacity. Final end positions may either likewise be contained in the signal, or determined on-site by the mobile units or further units on site, such as a parking facility management system.

Alternatively, the signal may also be emitted individually for each mobile unit located in the affected area, however, and may contain an appropriately individual safe position for this unit. This position may be, for example, a parking space in a parking garage, or an area which is not affected by the piece of hazard information or a hazard.

In one further specific embodiment of the method, the method includes the additional step of calculating a possible route for the mobile unit to the determined safe position. In the step of emitting the signal, the signal encompasses a piece of information regarding the route for the mobile unit.

This specific embodiment offers the advantage that an optimal route may be created on the basis of the present data, which enhances the safety of the mobile unit to which the signal is emitted. At least one individual route may be created for each mobile unit with the aid of the method. Multiple routes may also be determined, of which one may be subsequently selected by the mobile unit. This has the advantage that further pieces of surroundings information which are exclusively available to the mobile unit, since these pieces of surroundings information are detected, for example, by the mobile unit with the aid of a surroundings sensor system, may be incorporated into the route planning, whereby the safety for the mobile unit is further enhanced.

In one further specific embodiment of the method, the method includes the step of emitting a further signal to a user and/or an owner of the mobile unit and/or a party responsible for the mobile unit. In this case, the signal encompasses a piece of information regarding the emission of the signal which encompasses a piece of hazard information to the mobile unit.

This specific embodiment of the method offers the advantage that a user and/or an owner of the mobile unit and/or a party responsible for the mobile unit are/is informed about an impending hazard and, consequently, may take precautions which further enhance the safety of the mobile unit.

In addition, a device is provided which is configured for carrying out the above-described method for emitting a signal.

Moreover, a computer program is provided, which is configured for carrying out one of the above-described methods. In addition, a machine-readable memory medium is provided, on which this computer program is stored.

The above-described methods for controlling a mobile unit and for emitting a signal which encompasses a piece of hazard information may also be combined, of course, so that a method is obtained, which includes all necessary steps of both methods and is carried out on multiple separate units which may directly or indirectly communicate with one another.

### BRIEF DESCRIPTION OF THE DRAWINGS

FIG. 1 shows a flow chart of one specific embodiment of the method for controlling a unit operated in an automated manner according to the present invention.

FIG. 2 shows a flow chart of one further specific embodiment of the method for controlling a unit operated in an automated manner according to the present invention.

FIG. 3 shows a flow chart of one further specific embodiment of the method for controlling a unit operated in an automated manner according to the present invention.

FIG. 4 shows a flow chart of one specific embodiment of the method for generating and emitting a piece of hazard information according to the present invention.

FIG. 5 shows a flow chart of one specific embodiment of the method for generating and emitting a piece of hazard information according to the present invention.

### DETAILED DESCRIPTION

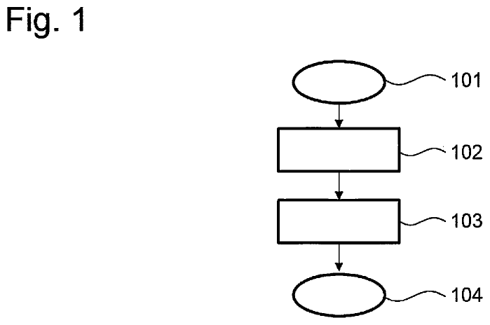

A method for controlling a unit operated in an automated manner is outlined in FIG. 1. In this specific embodiment, the mobile unit operated in an automated manner is a drone which is equipped with multiple cameras, a GPS sensor, a communication unit, and a control unit. The control unit is configured in such a way, in this case, that an automated control of the drone is possible, in that appropriate actuators are activated without the need to intervene in the control of the drone with the aid of an external activation. Moreover, the control unit is configured for carrying out the method represented in FIG. 1. With the aid of the communication unit, the drone is capable of receiving signals from external sources and emitting signals. In this exemplary embodiment, the communication unit is configured for receiving and emitting signals via the mobile radio communication and via a WLAN.

The method starts in step 101.

In step 102, a signal of an external weather server, which encompasses a piece of hazard information, is received by the control unit via the communication unit. In this specific embodiment, the piece of hazard information contains a warning against hail and a storm which are to occur in an indicated area in an indicated period of time.

In step 103, an automated guidance of the drone takes place based on this piece of hazard information. Safe positions for the drone, to which the drone may return or move in the event that hazards occur, are stored on an internal memory which is likewise a component of the drone. Based on the received piece of hazard information, one of these safe positions is selected by the drone; in this exemplary embodiment, the safe position is a space in an underground parking garage reserved for the drone. The drone is guided in an automated manner in such a way that the drone reaches its safe position before the beginning of the forecast hail.

The method ends in step 104.

Instead of a drone, the mobile unit operated in an automated manner may also be a motor vehicle operable in an automated manner or further agricultural vehicles, watercraft, aircraft, and/or spacecraft. These vehicles are likewise equipped in such a way that they may receive signals and move in an automated manner to predefined locations.

Instead of ascertaining a safe position on its own, in an alternative specific embodiment, the safe position is already contained in the piece of hazard information. In addition, in a further specific embodiment, the route to the safe position is also already contained in the piece of hazard information.

In an alternative specific embodiment, both the determination of a safe position as well as the calculation of a route to the safe position take place in the mobile unit.

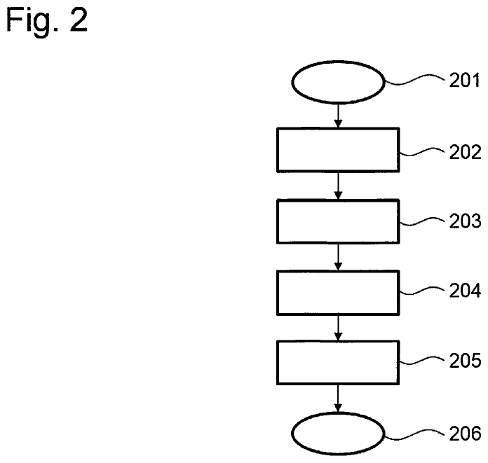

A further possible sequence of the method is represented in FIG. 2. In this specific embodiment, the method runs on a motor vehicle operated in an automated manner. The motor vehicle includes a control unit, a surroundings sensor system, and a communication unit. The motor vehicle may be operated in an automated manner via the control unit with the aid of signals received via the surroundings sensor system. Signals may be received from external sources and signals may be emitted with the aid of the communication unit.

The method starts in step 201.

In step 202, a signal of an external source is received by the control unit via the communication unit; in this exemplary embodiment, by a cloud on which data are aggregated and hazard information is generated. The received signal encompasses a piece of hazard information in which an area is contained, in which a hazard is to be assumed. In this exemplary embodiment, the piece of hazard information contains information regarding impending or existing riots or an unscheduled demonstration. Moreover, the signal of the external source contains an individually determined safe position for the vehicle and multiple proposed routes sorted by priority, which may be headed for by the vehicle in order to reach the safe position. In the vehicle, the various routes are compared with data regarding known route sections stored in the vehicle and a prioritized route is selected based on the comparison. The prioritized route is selected in such a way that known hazards may be avoided. If no further hazards are known, the route prioritized by the external source is selected.

In step 203, the vehicle transmits a signal to a vehicle owner with the aid of the communication unit, in which information regarding the impending hazard and the planned guidance to the safe position is contained.

In step 204, an acknowledge signal which was emitted by the vehicle owner is received via the communication unit.

After this acknowledge signal has been received, the automated guidance of the vehicle takes place in step 205 in such a way that the safe position is headed for along the previously established route.

The method ends in step 206.

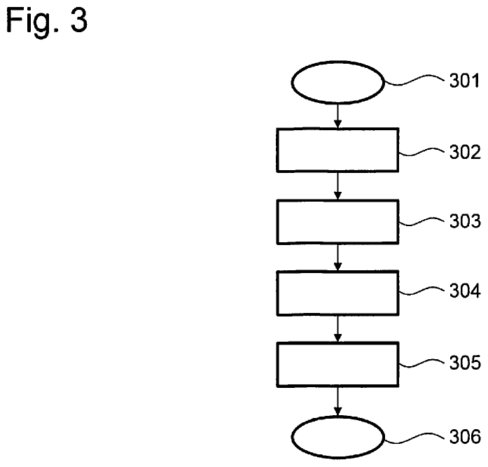

A further possible sequence of the method is outlined in FIG. 3. In this exemplary embodiment, the mobile unit is a tractor operable in an automated manner.

The method starts in step 301.

In step 302, a signal of an external server, which contains a piece of information regarding impending heavy rain, is received by the tractor. The tractor is positioned in the proximity of a field, so that it may be utilized on the field upon request without a great time delay.

In order to prevent the tractor from sinking in or incurring any other type of damage due to the heavy rain, a control of the tractor takes place in step 303 based on the information regarding the heavy rain. The control takes place in such a way that the tractor heads for a covered parking position. This safe position for the tractor is stored in an internal memory of the tractor and is to be prioritized by the tractor as a safe position in the case of heavy rain.

In step 304, the tractor receives a further signal which contains an all-clear signal regarding the heavy rain.

Based on this information, in step 305, an automated guidance of the tractor back to the position takes place, in which the tractor was located when it received the heavy rain warning. This position was previously stored in the tractor. The method ends in step 306.

In one further specific embodiment of the method, in step 304, a guidance signal is received, which was emitted by the owner of the tractor. This signal contains a control command which is independent of a hazard situation. The signal also contains a position which the tractor is to head for, instead of the safe position. The position is selected regardless of the heavy rain warning in this case and corresponds to a parking space on a yard covered with concrete.

In one further exemplary embodiment, step 304 of receiving a further signal is dispensed with. The automated guidance of the tractor in step 305 takes place based on the piece of hazard information contained in step 302. In this exemplary embodiment, this piece of hazard information contains a period of time in which a hazard is to be assumed. The automated guidance of the tractor back to a starting position takes place immediately after the period of time contained in the piece of hazard information.

In one further exemplary embodiment, the signal received in step 304 is emitted by a user of the tractor, since the user does not agree with the automated control. Consequently, in step 305, the tractor moves back to the starting position, regardless of a present piece of hazard information.

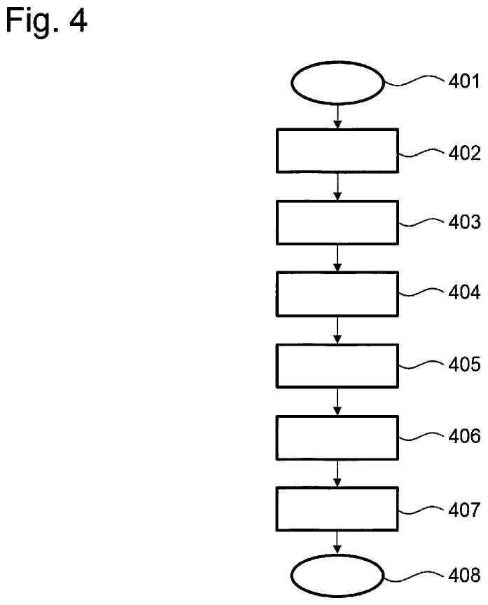

A further method diagram is represented in FIG. 4. The represented method may be carried out, for example, on an external server which is capable of receiving data via a suitable interface. In this exemplary embodiment, the method is carried out on a cloud.

The method starts in step 401.

In step 402, data are received by the cloud. This takes place in this exemplary embodiment via a suitable interface which is configured for receiving mobile radio signals and includes a connection to the Internet. The received data are various types of data from which a piece of hazard information is derivable, if necessary. These data encompass, for example, weather data, such as imminent hail, heavy rain, rain, a storm, warnings about natural disasters such as imminent high water, a tsunami, an earthquake, a landslide, a wildfire, a hurricane, or a heavy snowfall and, if necessary, the risk of avalanches, or warnings about hazards to an owner of a mobile unit, for example, due to an imminent stopping restriction at the present position of the mobile unit due to temporary construction work. Moreover, it may also be assumed that demonstrations or similar events, for example, assemblies of multiple persons or vehicles, pose a hazard. Consequently, data from weather stations, communications data, and data regarding GPS positions of persons or mobile units are received, on the basis of which occurring gatherings of people or growing groups of mobile units may be determined, if necessary.

In step 403, a piece of hazard information is generated on the basis of the received data. In this exemplary embodiment, an unusual gathering of pedestrians is detected on the basis of position data of pedestrians. Simultaneously, messages are received, which contain information regarding a possible demonstration including violent participants in a certain area.

This information is combined with the detected assembly, whereby a piece of hazard information is obtained, which contains information regarding an impending demonstration, which could result in hazards for vehicles located in the proximity.

In step 404, the area affected by the piece of hazard information is ascertained on the basis of the received data. In this exemplary embodiment, a radius of 5 km around the focus of the assembly or the gathering of pedestrians is established as a danger zone.

In step 405, the position of a mobile unit is received via a receiving unit. In this exemplary embodiment, information regarding the mobile unit has already been stored, so that the location of this unit may be queried in a targeted manner.

In step 406, it is detected whether the mobile unit is located in the previously determined area which is affected by the piece of hazard information.

If it is established in step 406 that the mobile unit is located in an area, which is affected by the piece of hazard information, at the point in time of the query, an emission of a signal, which encompasses the hazard information, to the mobile unit takes place in step 407. The method ends in step 408.

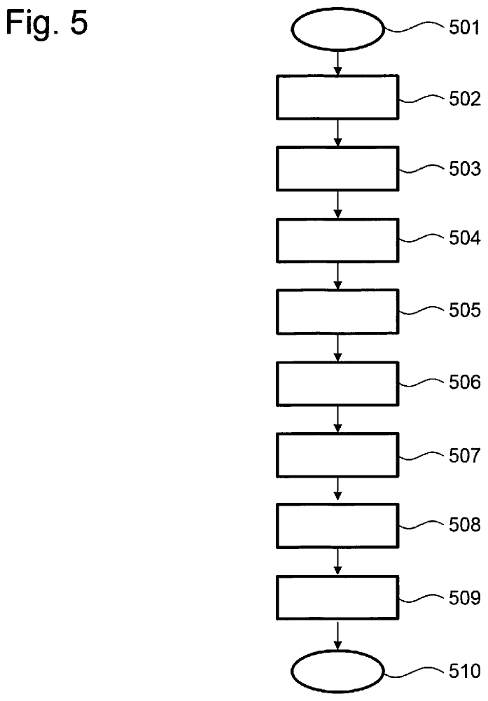

A further method for emitting a signal is outlined in FIG. 5. In this exemplary embodiment, this method is carried out in a cloud.

The method starts in step 501.

In step 502, data regarding an appropriate interface are received from the cloud which is formed by multiple servers networked with one another. In this exemplary embodiment, the received data encompass a storm warning for the greater Munich area, in which strong hail is to be expected.

In step 503, a piece of hazard information is generated on the basis of these data, in that the data received in step 502 are analyzed. The aforementioned data contain the information regarding the forecast hail.

In step 504, an area is ascertained, which is or is to be affected by the piece of hazard information or by the hail. In this case, a radius is assumed, which is 50 km greater than the area indicated in the received data, in which hail is to be expected.

In step 505, position data of multiple mobile units are received, which are registered in the cloud and are to receive hazard information relevant for the mobile units.

In step 506, it is ascertained whether the mobile units are located in the area affected by the piece of hazard information or will be located there at the point in time of the occurring hazard. Where the mobile units will be located at the point in time of the hazard may be determined, for example, by querying the planned routes of the mobile units.

In step 507, a safe position is individually determined for each mobile unit which is located or is to be located in an area affected by the piece of hazard information. The type of mobile unit is taken into account in this case. Various vehicles, such as drones, automobiles, trucks, boats, agricultural machinery, aircraft, or spacecraft, may be registered.

In step 508, at least one route to the safe position determined in step 507 is individually calculated for each mobile unit. The manner in which the mobile unit may move, for example, whether it may fly or travel over water, or whether it is permitted to utilize or must utilize only certain roads, is also taken into account in this calculation.

The emission of a signal to all mobile units which are or will be located in an area affected by the piece of hazard information takes place in step 509. In this case, the signal contains the piece of hazard information, the individually determined safe position, and at least one route which may be traveled or is permitted to be traveled by the particular mobile unit in order to reach the safe position. Multiple routes or “proposals for evacuation” are transmitted only when this is desired by the particular units. This option may be selected, for example, during a registration of the units in the cloud.

The method ends in step 510.

In an optional additional step, a further signal may be emitted to a user, an owner, or a party responsible for the particular mobile unit before, simultaneously to, or after the emission of the signal to the mobile units, so that the user, the owner, or the party responsible for the particular mobile unit is informed about the impending control of the mobile unit and may intervene in this control, if necessary.

The above-described methods may also be combined with one another, of course. Individual steps may be added to each presented method or, if necessary, may also be left out. The listed exemplary embodiments are by no means to be understood as a complete list of all possible and reasonable combinations. In addition, the individual method steps of the above-described methods may be carried out on a shared control unit or in a combination of multiple control units.

1-15. (canceled)

16. A method for controlling and/or evacuating a mobile unit operated in an automated manner, the method comprising:
receiving a signal from an external source, which encompasses a piece of hazard information;
providing automated control of the mobile unit based on this piece of hazard information, the control taking place so that the mobile unit is guided to a safe position for the mobile unit; and
automatically guiding the mobile unit based on the piece of hazard information and/or a received all-clear signal and/or a received guidance signal, the automatic guidance taking place so that the mobile unit is guided to a starting position of the mobile unit.

17. The method of claim 16, wherein the starting position is the position of the mobile unit, in which the mobile unit was located upon receipt of the signal from the external source, which encompasses a piece of hazard information.

18. The method of claim 16, wherein the starting position is a position in a predefined surrounding area of the position in which the mobile unit was located upon receipt of the signal from the external source, which encompasses a piece of hazard information.

19. The method of claim 18, wherein the surrounding area is a radius indicated in meters and/or kilometers.

20. The method of claim 18, wherein the surrounding area is established based on a time specification within which a certain location is to be reachable by the mobile unit.

21. The method of claim 16, further comprising:
emitting a signal to a user and/or an owner of the mobile unit and/or a party responsible for the mobile unit, which encompasses a piece of information regarding an automated control of the mobile unit.

22. The method of claim 16, further comprising:
receiving an acknowledge signal of the user and/or the owner and/or the party responsible for the mobile unit, the automated guidance of the mobile unit taking place based on the acknowledge signal.

23. The method of claim 16, wherein the automated mobile unit is an automobile, a drone, a truck, a boat, a construction vehicle, a commercial vehicle, a tractor, an aircraft, or a spacecraft.

24. An apparatus for controlling and/or evacuating a mobile unit operated in an automated manner, comprising:
a device configured to perform the following:
receiving a signal from an external source, which encompasses a piece of hazard information;
providing automated control of the mobile unit based on this piece of hazard information, the control taking place so that the mobile unit is guided to a safe position for the mobile unit; and
automatically guiding the mobile unit based on the piece of hazard information and/or a received all-clear signal and/or a received guidance signal, the automatic guidance taking place so that the mobile unit is guided to a starting position of the mobile unit.

25. A method for emitting a signal which encompasses a piece of hazard information, the method comprising:
receiving data;
generating a piece of hazard information on the basis of the received data;
ascertaining an area affected by the piece of hazard information;
receiving position data of at least one mobile unit;
ascertaining whether the mobile unit is located in the ascertained area;
emitting a signal which encompasses the hazard information to the mobile unit if the mobile unit is located in the ascertained area; and
emitting a further signal to a user and/or an owner of the mobile unit and/or a party responsible for the mobile unit, which encompasses a piece of information regarding the emission of the signal to the mobile unit.

26. The method of claim 25, further comprising:
determining a safe position for the mobile unit, the signal encompassing a piece of information regarding the safe position for the mobile unit.

27. The method of claim 26, further comprising:
calculating a possible route for the mobile unit to the determined safe position, the signal, in the step of emitting the signal, encompassing a piece of information regarding the route for the mobile unit.

28. An apparatus, comprising:
a device, for emitting a signal which encompasses a piece of hazard information, configured to perform the following:
receiving data;
generating a piece of hazard information on the basis of the received data;
ascertaining an area affected by the piece of hazard information;
receiving position data of at least one mobile unit;
ascertaining whether the mobile unit is located in the ascertained area;
emitting a signal which encompasses the hazard information to the mobile unit if the mobile unit is located in the ascertained area; and
emitting a further signal to a user and/or an owner of the mobile unit and/or a party responsible for the mobile unit, which encompasses a piece of information regarding the emission of the signal to the mobile unit.

29. A non-transitory computer readable medium having a computer program, which is executable by a processor, comprising:
a program code arrangement having program code for controlling and/or evacuating a mobile unit operated in an automated manner, by performing the following:
receiving a signal from an external source, which encompasses a piece of hazard information;
providing automated control of the mobile unit based on this piece of hazard information, the control taking place so that the mobile unit is guided to a safe position for the mobile unit; and
automatically guiding the mobile unit based on the piece of hazard information and/or a received all-clear signal and/or a received guidance signal, the automatic guidance taking place so that the mobile unit is guided to a starting position of the mobile unit.

30. The computer readable medium of claim 29, wherein the starting position is the position of the mobile unit, in which the mobile unit was located upon receipt of the signal from the external source, which encompasses a piece of hazard information.
